(19) United States
(12) Patent Application Publication
(10) Pub. No.: US 2026/0128578 A1
(43) Pub. Date: May 7, 2026

(54) Overmolded Interconnect Device

(71) Applicant: Valeo Vision, Bobigny (FR)

(72) Inventor: Andrew Massey, Seymour, IN (US)

(21) Appl. No.: 18/934,932

(22) Filed: Nov. 1, 2024

(51) Int. Cl. H02G 3/38; B60R 16/02; B60R 16/03; H01B 7/00; H02G 3/04

(52) U.S. Cl. CPC H02G 3/28; B60R 16/03; H01B 7/0045; H02G 3/0437; B60R 16/0207

(57) ABSTRACT

A method for forming an overmolded interconnect device includes molding a first layer of an automotive component having a surface, depositing conductive material onto a portion of the surface, and molding a second layer over the surface to substantially enclose at least a portion of the conductive material between the first layer and the second layer.

### TECHNICAL FIELD

This disclosure relates to overmolded interconnected devices and, more particularly, to systems and methods for embedding wiring within molded parts.

### BACKGROUND

A vehicle may include many types of electronics. Wiring harnesses are often used to organize electrical wires within the vehicle. However, wiring harnesses may be inefficient, impractical, unsightly, expensive, or too fragile for some vehicle parts. Therefore, there is a need for alternative electric wire organization.

### SUMMARY

The present teachings provide a method including molding a first layer of an automotive component having a surface, depositing conductive material onto a portion of the surface, and molding a second layer over the surface to substantially enclose at least a portion of the conductive material between the first layer and the second layer.

The present teachings provide a method including forming a first layer of a part in a first shot of an injection molding process, masking some of the first layer so that a surface of the first layer is exposed, depositing conductive material onto the surface, forming a second layer of the part in a second shot of the injection molding process, and enclosing, during the forming the second layer by the second shot, at least a portion of the conductive material between the first layer and the second layer.

The present teachings provide an apparatus including a first layer of polymeric material, a circuit, and a second layer covering at least a portion of the first layer and enclosing at least a portion of the circuit between the first layer and the second layer. The circuit includes a first electrically conductive path with a first terminal and a second electrically conductive path with a second terminal. The apparatus is part of a vehicle.

### BRIEF DESCRIPTION OF THE DRAWINGS

FIG. 1 is a side view of a vehicle including a vehicle grille with an array of embedded lights.

FIG. 2A is an elevation view of a vehicle grille with an array of embedded lights.

FIG. 2B is a schematic illustration of a circuit encapsulated within the vehicle grille of FIG. 2A during a molding process.

FIG. 2C is an elevation view of the vehicle grille of FIG. 2A showing circuits encapsulated within the vehicle grille.

FIG. 3A is a cross-sectional view of a first layer formed in a molding process.

FIG. 3B is a cross-sectional view of the first layer of FIG. 3A and an insulated conductor, wherein the insulated conductor is partially nested in the first layer.

FIG. 3C is a cross-sectional view of a second layer formed in the molding process, wherein the second layer is overmolded with respect to the first layer and insulated conductor of FIG. 3B.

FIG. 4 is a flowchart of a method for encapsulating a conductive material during a molding process.

FIG. 5A is a cross-sectional view of a first layer formed in a molding process.

FIG. 5B is a cross-sectional view of the first layer of FIG. 5A and a mask to guide conductive material onto the first layer.

FIG. 5C is a cross-sectional view of the first layer of FIG. 5B and the mask with deposited conductive material.

FIG. 5D is a cross-sectional view of a second layer formed in the molding process, wherein the second layer is overmolded with respect to the first layer and deposited conductive material of FIG. 5C.

FIG. 6 is a flowchart of a method for encapsulating deposited conductive material during a molding process.

FIG. 7A is a cross-sectional view of a first layer formed in a molding process.

FIG. 7B is a cross-sectional view of the first layer of FIG. 7A with deposited first conductive material.

FIG. 7C is a cross-sectional view of a second layer formed in the molding process, wherein the second layer is partially overmolded with respect to the first layer and deposited first conductive material of FIG. 7B.

FIG. 7D is a cross-sectional view of the first layer, deposited first conductive material, and the second layer of FIG. 7C with deposited second conductive material.

FIG. 7E is a cross-sectional view of a third layer formed in the molding process and an insulated wire connected to the deposited second conductive material, wherein the third layer is overmolded with respect to the first layer, the second layer, and deposited second conductive material of FIG. 7D.

FIG. 7F is a cross-sectional view of a third layer formed in the molding process and a terminal connected to the deposited second conductive material, wherein the third layer is overmolded with respect to the first layer, the second layer, and deposited second conductive material of FIG. 7D.

FIG. 8 is a flowchart of a method for encapsulating deposited first conductive material and deposited second conductive material during a molding process.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Wiring harnesses are often used to organize electrical connections within a vehicle or part of the vehicle. However, wiring harnesses may take up a large amount of space, may be expensive to produce, or may be difficult to assemble in the space required (e.g., when working with small or thin parts). Wiring harnesses may also be considered unattractive and vehicle manufacturers may avoid using wiring harnesses in areas that may be visible. Additionally, handling of or inadvertent contact with wiring harnesses during shipment, vehicle production, or use of the vehicle may cause damage to the wire harness, including pinched or cut wires.

A part of the vehicle may be able to be manufactured to include wiring within the part, removing the need to attach a wiring harness. The part may be created using a multi-stage injection molding process. For example, a first layer of the part is injected into a mold, the mold is opened, a conductive material is deposited onto the first layer, the mold is closed, and a second layer of the part is injected into the mold. The conductive material deposited onto the first layer may be sprayed onto the first layer over or using a mask. Alternatively, the conductive material deposited onto the first layer may be a wiring harness that is routed along the first layer or a pre-cut sheet of conductive material placed onto the first layer.

The process may be scalable to multiple layers. For example, after the second layer of the part is injected into the mold, the mold may be opened again, a conductive material may be deposited onto the second layer, the mold may be closed, and a third layer of the part may be injected into the mold. Multiple layers may allow electrical pathways to cross over one another while remaining electrically insulated. Multiple layers may allow more complex parts to be efficiently designed.

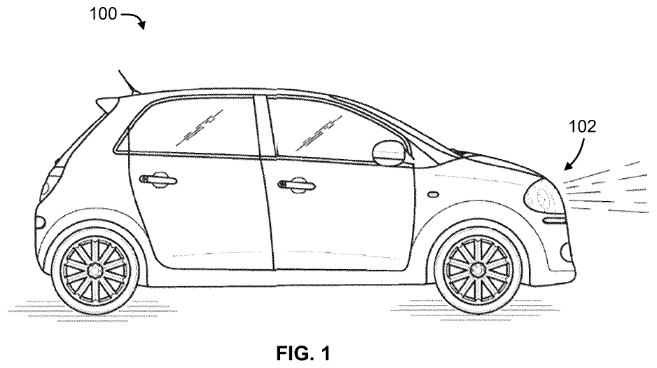

Referring to FIG. 1, a vehicle 100 is shown. The vehicle 100 may include one or more wiring harnesses to organize electrical wires within the vehicle 100. Alternatively, the vehicle may include one or more overmolded interconnect devices in place of all or a portion of the one or more wiring harnesses. The overmolded interconnect device may be a molded part of the vehicle 100 containing embedded wiring. The overmolded interconnect device may allow wiring to be more cost effective, hidden within the molded part, less fragile, or the like. Additionally, the overmolded interconnect device may allow wiring to be embedded in thin sections of the molded part where a wiring harness would otherwise need to be attached to the thin sections, which may be unsightly or more likely to damage the wiring harness.

The vehicle 100 may include a vehicle front 102. The vehicle front 102 may include a grille. The vehicle front 102 may include one or more light sources. Light may extend from the light sources in the vehicle front 102 away from the vehicle 100. Alternatively or additionally, the vehicle 100 may include light sources in other areas, for example, a vehicle rear, a vehicle side, a vehicle roof, a vehicle underside, a vehicle interior, or the like.

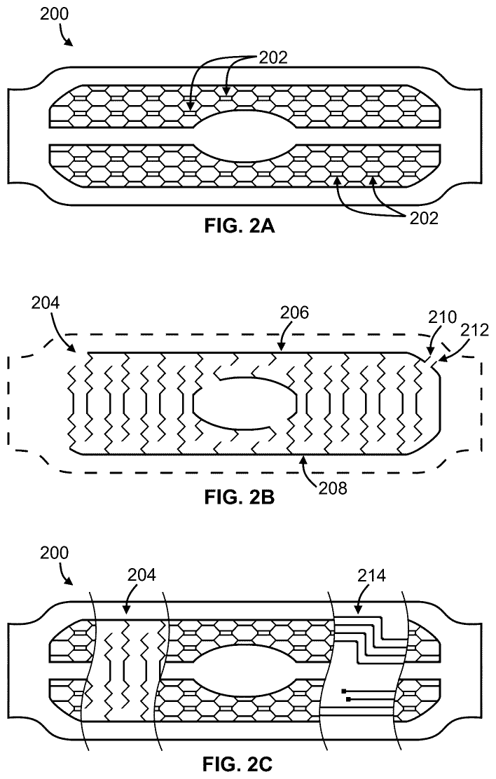

Referring to FIGS. 2A and 2B, a grille 200 is shown. The grille 200 may be located in the vehicle front 102. The grille 200 may be an overmolded interconnect device. The grille 200 may contain one or more electrical components 202. The one or more electrical components 202 may be embedded in a surface (e.g., a first layer) of the grille 200. The one or more electrical components 202 may be at least partially exposed through the surface of the grille 200. The one or more electrical components 202 may be a light source (e.g., a light-emitting diode (LED), an incandescent bulb, fluorescent light, compact fluorescent lamp, halogen lamp, high intensity discharge (HID) lamps, halogen lights, xenon lights, a laser diode, phosphorous bulb, or a combination thereof), a sensor, a camera, a turn indicator, a horn, or the like or any combination or sub-combination thereof.

The grille 200 may contain a circuit 204. At least a portion of the circuit 204 may be embedded in the grille 200. For example, the circuit 204 may be placed between layers (e.g., the first layer and a second layer) of the grille 200. The circuit 204 may comprise a conductive material (e.g., all or a portion of a wiring harness, conductive wire, insulated wire, a conductive sheet stamped or otherwise cut to form a desired conductive path, a conductive material capable of being sprayed or otherwise deposited onto a surface or substrate, a conductive material molded into a surface or substrate, a conductive material printed or painted onto a surface, a conductive powder, a conductive film, a conductive material encapsulated in a polymer, or the like or any combination or sub-combination thereof).

The circuit 204 may comprise a first path 206 and a second path 208. The first path 206 and the second path 208 may be formed using the conductive material. The first path 206 may be configured to connect to a first electrical connector of the one or more electrical components 202. For example, the first path 206 may be connected to the anode of each of the one or more electrical components 202. The second path 208 may be configured to connect to a second electrical connector of the one or more electrical components 202. For example, the second path 208 may be connected to the cathode of each of the one or more electrical components 202.

The portion of the circuit 204 embedded in the grille 200 may include at least a portion of the first path 206 and at least a portion of the second path 208. In certain implementations, the portion of the circuit 204 embedded in the grille 200 may include at least a portion of the first path 206 and not include a portion of the second path 208. In other implementations, the portion of the circuit 204 embedded in the grille 200 may include at least a portion of the second path 208 and not include a portion of the first path 206.

The first path 206 may terminate with a first terminal 210. The second path 208 may terminate with a second terminal 212. The circuit 204 may be embedded in the grille 200, and the first terminal 210 and the second terminal 212 may extend through the grille 200 and be exposed. The first terminal 210 and the second terminal 212 may be configured to electrically connect to a voltage source. The voltage source may be another part of the vehicle 100, for example, a wiring harness, a battery, or the like. The first terminal 210 and the second terminal 212 may be connected to the voltage source to form a complete circuit with the one or more electrical components 202 connected in parallel by the first path 206 and the second path 208.

Referring to FIG. 2C, the grille 200 may contain the circuit 204 and a second circuit 214. At least a portion of the second circuit 214 may be embedded in the grille 200. For example, the second circuit 214 may be placed between layers (e.g., the second layer and a third layer) of the grille 200. The second circuit 214 may comprise a conductive material (e.g., all or a portion of a wiring harness, conductive wire, insulated wire, a conductive sheet stamped or otherwise cut to form a desired conductive path, a conductive material capable of being sprayed or otherwise deposited onto a surface or substrate, a conductive material molded into a surface or substrate, a conductive material printed or painted onto a surface, a conductive powder, a conductive film, a conductive material encapsulated in a polymer, or the like or any combination or sub-combination thereof). The second circuit 214 may be electrically insulated from the circuit 204 (e.g., by the second layer). Alternatively, the second circuit 214 may be electrically connected to the circuit 204. For example, the second circuit 214 may be electrically connected to the first path 206, the second path 208, or both. The second circuit 214 may comprise a third path. The third path may be formed using the conductive material. The third path may be configured to connect to the one or more electrical components 202.

The grille 200 may contain one or more circuits (e.g., the circuit 204, the second circuit 214) comprising one or more electrically conductive paths (e.g., the first path 206, the second path 208, the third path). The grille 200 may comprise two or more layers (e.g., the first layer, the second layer, the third layer). In certain implementations, the number of electrically conductive paths within the grille 200 may correspond to the number of layers of the grille 200. For example, the number of electrically conductive paths may be equal to the number of layers. In another example, the number of electrically conductive paths may be more than the number of layers (e.g., N+1, N+2, N+3, N+4, N+5, etc., where N is the number of layers). In this example, there may be at least one electrically conductive path between each of the layers. In another example, the number of layers may be greater than the number of electrically conductive paths. In this example, there may be layers formed without an electrically conductive path between them.

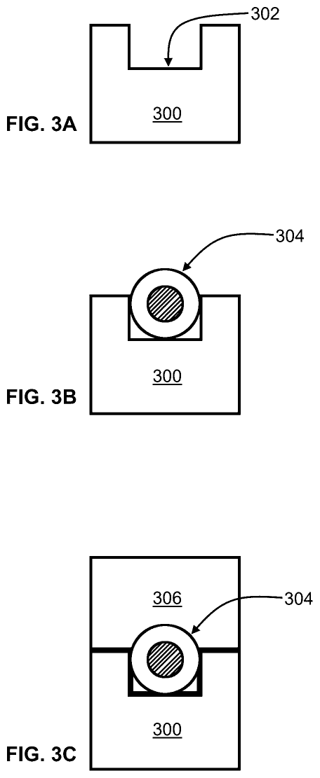

Referring to FIG. 3A, a first layer 300 is shown. The first layer 300 may be a first layer of an automotive component. The first layer 300 may have a surface 302. The surface 302 of the first layer 300 may be flat, grooved, curved, or the like or any combination or sub-combination thereof.

Referring to FIG. 3B, the first layer 300 is shown with a conductive material 304 deposited on the surface 302. The surface 302 may be configured to receive the conductive material 304. The conductive material 304 may comprise all or a portion of a wiring harness, conductive wire, insulated wire, a conductive sheet stamped or otherwise cut to form a desired conductive path, a conductive material capable of being sprayed or otherwise deposited onto a surface or substrate, a conductive material molded into a surface or substrate, a conductive material printed or painted onto a surface, a conductive powder, a conductive film, a conductive material encapsulated in a polymer, or the like or any combination or sub-combination thereof.

Referring to FIG. 3C, the first layer 300 is shown with a second layer 306 formed over the first layer 300. The second layer 306 may be a second layer of the automotive component. The second layer 306 may be molded over the surface 302 of the first layer 300. The second layer 306 may be molded to substantially enclose at least a portion of the conductive material 304 between the first layer 300 and the second layer 306.

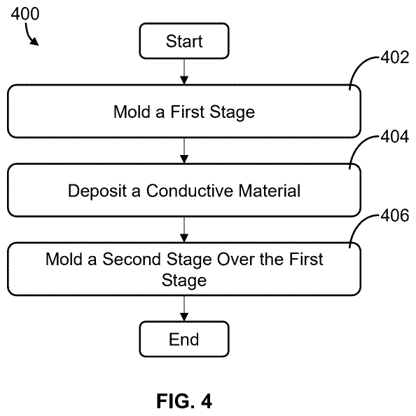

Referring to FIG. 4, a first process 400 is shown. The first process 400 may be used to form an automotive component with embedded wiring, for example, the grille 200, a headlight housing, an interior lighting component, a speaker, a connector, trim, or the like. Alternatively, the first process 400 may be used to form other objects, for example, lamps, signs, decorations, clocks, chairs, containers, handheld devices (e.g., electric toothbrush, hair dryer, massager, or the like), remote controls, video game systems and/or controllers, kitchen appliances, wearable technology, or the like.

The first process 400 may include a first molding 402 that forms the first layer 300. The first molding 402 may include injection molding, extrusion molding, compression molding, blow molding, rotational molding, thermoforming, 3D printing, die-casting, computer numerical control (CNC) machining, potting using a solid or gelatinous compound, forming a layer using an epoxy resin, securing a preformed layer, curing a layer, or the like. For example, the first layer 300 may be formed during a first shot of an injection molding process using a polymeric material.

After the first molding 402, the first process 400 may include depositing 404 a conductive material 304 onto the first layer 300. The depositing 404 the conductive material 304 may include spraying, molding, printing, painting, or otherwise placing the conductive material 304 onto the first layer 300. The depositing 404 the conductive material 304 may create one or more electrically conductive paths (e.g., ground, power, neutral, communication line, or the like) on the first layer 300. The first layer 300 may have a surface 302 configured to receive the conductive material 304.

After the depositing 404, the first process 400 may include a second molding 406 that forms a second layer 306 over the first layer 300. The second molding 406 may include injection molding, extrusion molding, compression molding, blow molding, rotational molding, thermoforming, 3D printing, die-casting, computer numerical control (CNC) machining, potting using a solid or gelatinous compound, forming a layer using an epoxy resin, securing a preformed layer, curing a layer over the first layer 300, or the like. For example, the second layer 306 may be formed during a second shot of the injection molding process using a polymeric material. The second layer 306 may be molded over the surface 302 of the first layer 300. The second layer 306 may be molded to substantially enclose at least a portion of the conductive material 304 between the first layer 300 and the second layer 306. For example, a portion of the conductive material 304 may be positioned on the surface 302 of the first layer 300 such that the second molding 406 forms the second layer 306 over the portion of the conductive material 304 to enclose the portion of the conductive material 304 between the first layer 300 and the second layer 306.

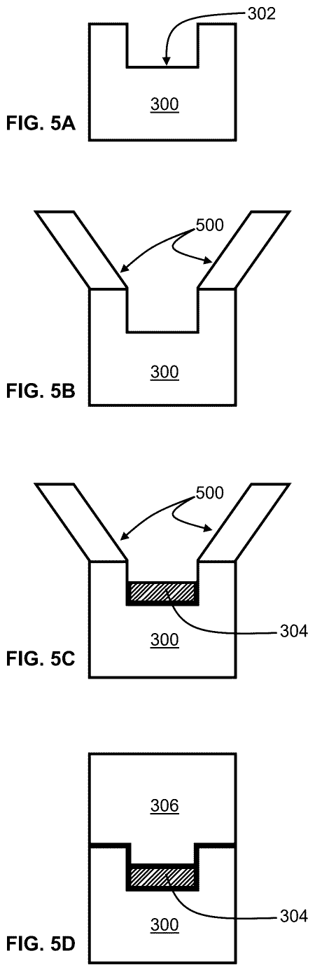

Referring to FIG. 5A, the first layer 300 is shown. The first layer 300 may be a first layer of an automotive component. The first layer 300 may have the surface 302. The surface 302 of the first layer 300 may be flat, grooved, curved, or the like or any combination or sub-combination thereof.

Referring to FIG. 5B, the first layer 300 is shown with a mask 500 (e.g., a stencil, a guide, a template, or the like). The mask 500 may partially cover the surface 302. The mask 500 may control where conductive material 304 is deposited. For example, the mask 500 may allow conductive material 304 to be deposited on the surface 302 of the first layer 300 while preventing the conductive material 304 from being deposited elsewhere.

Referring to FIG. 5C, the first layer 300 and the mask 500 are shown with the conductive material 304 deposited on the surface 302. The surface 302 may be configured to receive the conductive material 304. The conductive material 304 may comprise all or a portion of a wiring harness, conductive wire, insulated wire, a conductive sheet stamped or otherwise cut to form a desired conductive path, a conductive material capable of being sprayed or otherwise deposited onto a surface or substrate, a conductive material molded into a surface or substrate, a conductive material printed or painted onto a surface, a conductive powder, a conductive film, a conductive material encapsulated in a polymer, or the like or any combination or sub-combination thereof.

Referring to FIG. 5D, the first layer 300 is shown with the second layer 306 formed over the first layer 300. The second layer 306 may be a second layer of the automotive component. The second layer 306 may be molded over the surface 302 of the first layer 300. The second layer 306 may be molded to substantially enclose at least a portion of the conductive material 304 between the first layer 300 and the second layer 306.

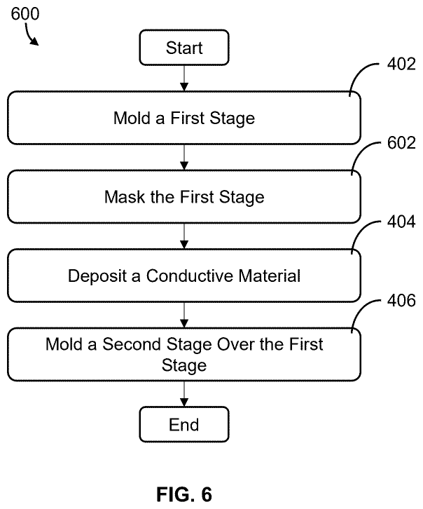

Referring to FIG. 6, a second process 600 is shown. The second process 600 may be used to form an automotive component with embedded wiring, for example, the grille 200, a headlight housing, an interior lighting component, a speaker, a connector, trim, or the like.

Alternatively, the second process 600 may be used to form other objects, for example, lamps, signs, decorations, clocks, chairs, containers, handheld devices (e.g., electric toothbrush, hair dryer, massager, or the like), remote controls, video game systems and/or controllers, kitchen appliances, wearable technology, or the like.

The second process 600 may include the first molding 402 that forms the first layer 300. After the first molding 402, the second process 600 may include masking 602 the first layer 300. Masking 602 the first layer 300 may include placing the mask 500 to at least partially cover the first layer 300. The mask 500 may allow conductive material 304 to be deposited on the surface 302 of the first layer 300 while preventing the conductive material 304 from being deposited elsewhere.

After the masking 602, the second process 600 may include depositing 404 the conductive material 304 onto the first layer 300. The depositing 404 the conductive material 304 may include spraying, molding, printing, painting, or otherwise placing the conductive material 304 onto the first layer 300. The depositing 404 may include spraying the conductive material 304 over the mask 500. Sprayed conductive material 304 may pool to form electrically conductive paths (e.g., the first path 206 and the second path 208) in areas where the mask 500 is absent (for example, the surface 302 of the first layer 300). Excess sprayed conductive material 304 may collect on a surface of the mask 500. After depositing 404 the conductive material 304, the mask 500 may be removed. Excess sprayed conductive material 304 may be removed from the mask 500 and recycled for future use.

After the depositing 404, the second process 600 may include the second molding 406 that forms the second layer 306 over the first layer 300. The second layer 306 may be molded over the surface 302 of the first layer 300. The second layer 306 may be molded to substantially enclose at least a portion of the conductive material 304 between the first layer 300 and the second layer 306. For example, a portion of the conductive material 304 may be positioned on the surface 302 of the first layer 300 such that the second molding 406 forms the second layer 306 over the portion of the conductive material 304 to enclose the portion of the conductive material 304 between the first layer 300 and the second layer 306. Before, during, or after the depositing 404 the second process 600 may include inserting an electrical connector. The electrical connector may facilitate an electrical connection to the conductive material 304. The electrical connector may be a wire, a terminal (e.g., the first terminal 210 or the second terminal 212), or the like. The second layer 306 may be molded around the electrical connector such that the electrical connector extends through the second layer 306.

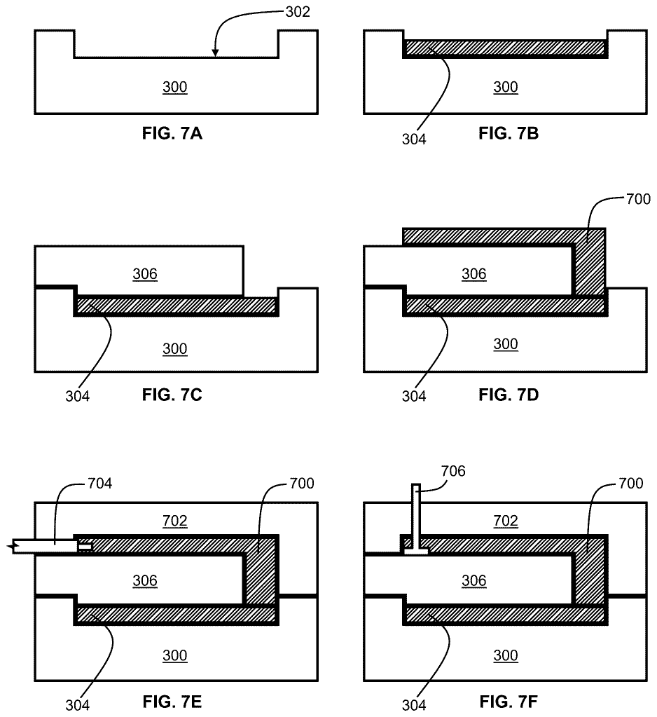

Referring to FIG. 7A, the first layer 300 is shown. The first layer 300 may be a first layer of an automotive component. The first layer 300 may have the surface 302. The surface 302 of the first layer 300 may be flat, grooved, curved, or the like or any combination or sub-combination thereof.

Referring to FIG. 7B, the first layer 300 is shown with the conductive material 304 deposited on the surface 302. The surface 302 may be configured to receive the conductive material 304. The conductive material 304 may comprise all or a portion of a wiring harness, conductive wire, insulated wire, a conductive sheet stamped or otherwise cut to form a desired conductive path, a conductive material capable of being sprayed or otherwise deposited onto a surface or substrate, a conductive material molded into a surface or substrate, a conductive material printed or painted onto a surface, a conductive powder, a conductive film, a conductive material encapsulated in a polymer, or the like or any combination or sub-combination thereof.

Referring to FIG. 7C, the first layer 300 is shown with the second layer 306 formed at least partially over the first layer 300. The second layer 306 may be a second layer of the automotive component. The second layer 306 may be molded over at least a portion of the surface 302 of the first layer 300. The second layer 306 may be molded to substantially enclose at least a portion of the conductive material 304 between the first layer 300 and the second layer 306.

Referring to FIG. 7D, the first layer 300, the conductive material 304, and the second layer 306 are shown with a second conductive material 700. The second conductive material 700 may be deposited on the second layer 306. The second layer 306 may have a surface configured to receive the second conductive material 700. The surface of the second layer 306 may be flat, grooved, curved, or the like or any combination or sub-combination thereof. The second conductive material 700 may comprise all or a portion of a wiring harness, conductive wire, insulated wire, a conductive sheet stamped or otherwise cut to form a desired conductive path, a conductive material capable of being sprayed or otherwise deposited onto a surface or substrate, a conductive material molded into a surface or substrate, a conductive material printed or painted onto a surface, a conductive powder, a conductive film, a conductive material encapsulated in a polymer, or the like or any combination or sub-combination thereof.

Referring to FIG. 7E, the first layer 300, the conductive material 304, the second layer 306, and the second conductive material 700 are shown with a third layer 702 formed at least partially over the second layer 306. The third layer 702 may be a third layer of the automotive component. A wire 704 may be in electrical connection with the second conductive material 700. The wire 704 may be an insulated wire. The wire 704 may extend beyond the automotive component.

Referring to FIG. 7F, the first layer 300, the conductive material 304, the second layer 306, and the second conductive material 700 are shown with the third layer 702 formed at least partially over the second layer 306. A terminal 706 (e.g., the first terminal 210 or the second terminal 212) may be in electrical connection with the second conductive material 700. The terminal 706 may extend through the third layer 702.

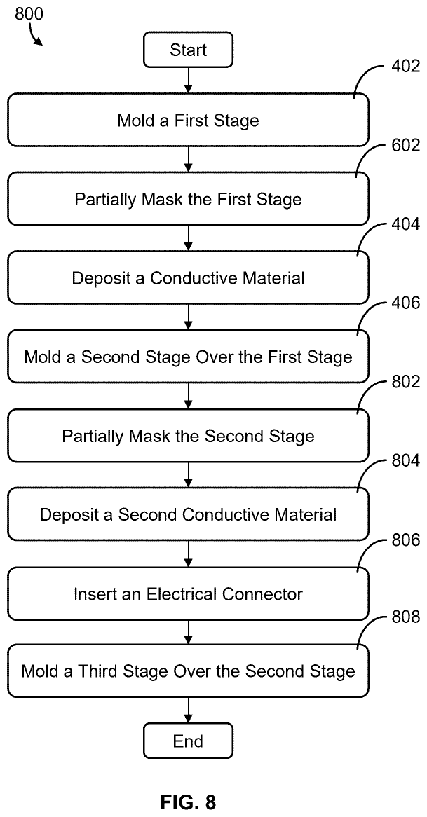

Referring to FIG. 8, a third process 800 is shown. The third process 800 may be used to form an automotive component with embedded wiring, for example, the grille 200, a headlight housing, an interior lighting component, a speaker, a connector, trim, or the like. Alternatively, the third process 800 may be used to form other objects, for example, lamps, signs, decorations, clocks, chairs, containers, handheld devices (e.g., electric toothbrush, hair dryer, massager, or the like), remote controls, video game systems and/or controllers, kitchen appliances, wearable technology, or the like.

The third process 800 may include the first molding 402 that forms the first layer 300. After the first molding 402, the third process 800 may include masking 602 the first layer 300 using the mask 500.

After the masking 602, the third process 800 may include depositing 404 the conductive material 304 onto the first layer 300. The depositing 404 the conductive material 304 may include spraying, molding, printing, painting, or otherwise placing the conductive material 304 onto the first layer 300. The depositing 404 may include spraying the conductive material 304 over the mask 500.

After the depositing 404, the third process 800 may include the second molding 406 that forms the second layer 306 over the first layer 300. The second layer 306 may be molded over the surface 302 of the first layer 300. The second layer 306 may be molded to substantially enclose at least a portion of the conductive material 304 between the first layer 300 and the second layer 306. For example, a portion of the conductive material 304 may be positioned on the surface 302 of the first layer 300 such that the second molding 406 forms the second layer 306 over the portion of the conductive material 304 to enclose the portion of the conductive material 304 between the first layer 300 and the second layer 306. After the second molding 406, at least a portion of the conductive material 304 may remain not covered by the second layer 306.

After the second molding 406, the third process 800 may include a second masking 802 of the second layer 306. The second masking 802 of the second layer 306 may include placing a second mask (e.g., a stencil, a guide, a template, or the like) to at least partially cover the second layer 306. Alternatively, the second masking 802 may use the mask 500 as the second mask. The second mask may control where the second conductive material 700 is deposited. For example, the second mask may allow the second conductive material 700 to be deposited on a surface of the second layer 306 while preventing the conductive material 304 from being deposited elsewhere.

After the second masking 802, the third process 800 may include a second depositing 804 of the second conductive material 700. The second depositing 804 of the second conductive material 700 may include spraying, molding, printing, painting, or otherwise placing the second conductive material 700 onto the second layer 306. The second depositing 804 may include spraying the second conductive material 700 over the second mask. Sprayed second conductive material 700 may pool to form electrically conductive paths in areas where the second mask is absent (for example, the surface of the second layer 306). Excess sprayed second conductive material 700 may collect on a surface of the second mask. After the second depositing 804 of the second conductive material 700, the second mask may be removed. Excess sprayed second conductive material 700 may be removed from the second mask and recycled for future use.

After the second depositing 804, the third process 800 may include inserting 806 an electrical connector. The electrical connector may facilitate an electrical connection to the second conductive material 700. The electrical connector may be the wire 704, the terminal 706 (e.g., the first terminal 210 or the second terminal 212), or the like. In certain implementations, the inserting 806 may occur before or during the second depositing 804.

After the inserting 806, the third process 800 may include a third molding 808 that forms the third layer 702 over the second layer 306. The third layer 702 may be molded over the surface of the second layer 306. The third layer 702 may be molded around the electrical connector such that the electrical connector extends through the third layer 702. The third layer 702 may be molded to substantially enclose at least a portion of the second conductive material 700 between the second layer 306 and the third layer 702. For example, a portion of the second conductive material 700 may be positioned on the surface of the second layer 306 such that the third molding 808 forms the third layer 702 over the portion of the second conductive material 700 to enclose the portion of the second conductive material 700 between the second layer 306 and the third layer 702. The second conductive material 700 may be electrically insulated from the conductive material 304 by the second layer 306. Alternatively, the second conductive material 700 may be electrically connected to the conductive material 304. After the third molding 808, at least a portion of the second conductive material 700 may remain not covered by the third layer 702.

The teachings provide that the first process 400, the second process 600, or the third process 800 may deposit both the conductive material 304 and the second conductive material 700 onto the first layer 300. The second conductive material 700 may be deposited onto a second portion of the surface 302 of the first layer 300. The second conductive material 700 may be sprayed onto the surface 302 of the first layer 300. The second conductive material 700 may be deposited after masking the surface 302 of the first layer 300 to expose the second portion of the surface 302. After depositing the second conductive material 700, the second molding 406 may form the second layer 306 over the first layer 300 to substantially enclose at least a portion of the conductive material 304 and at least a portion of the second conductive material 700 between the first layer 300 and the second layer 306.

The first process 400, the second process 600, and the third process 800 are represented as a series of steps but may be performed in a different order than described above. Additionally, a step or series of steps may be repeated within the first process 400, the second process 600, or the third process 800. For example, additional conductive material may be deposited, or additional layers may be formed.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30,” inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of or even consists of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A method, comprising:
molding a first layer of an automotive component having a surface;
depositing conductive material onto a portion of the surface; and
molding a second layer over the surface to substantially enclose at least a portion of the conductive material between the first layer and the second layer.

2. The method of claim 1, wherein the depositing comprises spraying the conductive material onto the surface.

3. The method of claim 2, further comprising:
masking, before the depositing of the conductive material, a portion of the surface from the spraying.

4. The method of claim 1, wherein:
the conductive material comprises a formed conductive sheet; and
the depositing comprises positioning the formed conductive sheet onto the surface.

5. The method of claim 1, wherein:
the conductive material comprises an insulated wire; and
the depositing comprises positioning the insulated wire onto the surface.

6. The method of claim 5, wherein:
the insulated wire comprises a portion of a wiring harness; and
the positioning comprises positioning the wiring harness onto the surface.

7. The method of claim 1, wherein:
the depositing comprises depositing second conductive material onto a second portion of the surface; and
the molding comprises molding the second layer over the first layer to substantially enclose at least a portion of the second conductive material between the first layer and the second layer.

8. The method of claim 1, wherein the second layer includes a second surface, the method further comprising:
depositing second conductive material onto the second surface; and
molding a third layer over the second surface to substantially enclose at least a portion of the second conductive material between the second layer and the third layer, wherein the second layer electrically insulates the at least the portion of the conductive material from the at least the portion of the second conductive material.

9. A method, comprising:
forming a first layer of a part in a first shot of an injection molding process;
masking some of the first layer so that a surface of the first layer is exposed;
depositing conductive material onto the surface;
forming a second layer of the part in a second shot of the injection molding process; and
enclosing, during the forming the second layer by the second shot, at least a portion of the conductive material between the first layer and the second layer.

10. The method of claim 9, wherein the depositing comprises spraying the conductive material onto the surface.

11. The method of claim 9, further comprising:
masking, before the forming the second layer of the part, the first layer a second time so that a second surface of the first layer is exposed; and
depositing second conductive material onto the second surface.

12. The method of claim 11, wherein the enclosing, during the forming the second layer by the second shot, includes at least a portion of the second conductive material between the first layer and the second layer.

13. The method of claim 9, further comprising:
masking some of the second layer so that a surface of the second layer is exposed;
depositing second conductive material onto the surface of the second layer;
forming a third layer of the part in a third shot of the injection molding process; and
enclosing, during the forming the third layer by the third shot, at least a portion of the second conductive material between the second layer and the third layer.

14. An apparatus, comprising:
a first layer of polymeric material;
a circuit, comprising:
a first electrically conductive path including a first terminal; and
a second electrically conductive path including a second terminal, wherein the first terminal and the second terminal are configured to connect to a power source; and
a second layer covering at least a portion of the first layer and enclosing at least a portion of the circuit between the first layer and the second layer, wherein the apparatus is part of a vehicle.

15. The apparatus of claim 14, further comprising:
an electrical component electrically connected to the first electrically conductive path and the second electrically conductive path.

16. The apparatus of claim 15, wherein the electrical component is a light source embedded into the first layer.

17. The apparatus of claim 16, wherein the light source is at least partially exposed through the first layer.

18. The apparatus of claim 14, wherein the first terminal and the second terminal are at least partially exposed through the second layer.

19. The apparatus of claim 14, wherein the portion of the circuit enclosed between the first layer and the second layer includes at least a portion of the first electrically conductive path and does not include a portion of the second electrically conductive path.

20. The apparatus of claim 14, further comprising:
a second circuit comprising a third electrically conductive path; and
a third layer covering at least a portion of the second layer and enclosing at least a portion of the second circuit between the second layer and the third layer.
